(19) United States
(12) Patent Application Publication
(10) Pub. No.: US 2025/0012654 A1
(43) Pub. Date: Jan. 9, 2025

(54) PRESSURE SENSOR

(71) Applicants: FUJIKIN INCORPORATED, Osaka (JP); NIDEC COMPONENTS CORPORATION, Tokyo (JP)

(72) Inventors: Kaoru Hirata, Osaka (JP); Keisuke Ideguchi, Osaka (JP); Shinya Ogawa, Osaka (JP); Katsuyuki Sugita, Osaka (JP); Masaaki Nagase, Osaka (JP); Kouji Nishino, Osaka (JP); Masaki Fukasawa, Sano-shi (JP); Yusuke Ishikawa, Sano-shi (JP)

(73) Assignees: FUJIKIN INCORPORATED, Osaka (JP); NIDEC COMPONENTS CORPORATION, Tokyo (JP)

(21) Appl. No.: 18/893,628

(22) Filed: Sep. 23, 2024

Related U.S. Application Data
(63) Continuation of application No. PCT/JP2023/008990, filed on Mar. 9, 2023.

(30) Foreign Application Priority Data
Mar. 24, 2022 (JP) 2022-048531

(51) Int. Cl. G01L 13/02; G01L 19/00; G01L 19/06

(52) U.S. Cl. CPC G01L 13/025; G01L 19/0007; G01L 19/0061; G01L 19/0618

(57) ABSTRACT

A pressure sensor that can prevent application of excessive stress on a port and detect fluid differential pressure accurately. A base includes a sensor that detects a pressure difference between a first fluid and a second fluid. A first port is attached to the base and has a first flow path through which the first fluid is introduced. A second port is attached to the base and has a second flow path through which the second fluid is introduced. The outer diameter of the first port is equal to the outer diameter of the second port, and the diameter of the first flow path is smaller than the diameter of the second flow path.

### CROSS-REFERENCE TO RELATED APPLICATIONS

This application is a Continuation Application of PCT Application No. PCT/JP2023/008990, filed Mar. 9, 2023 and based upon and claiming the benefit of priority from prior Japanese Patent Application No. 2022-048531, filed Mar. 24, 2022, the entire contents of all of which are incorporated herein by reference.

### BACKGROUND OF THE INVENTION

### 1. Field of the Invention

Embodiments described herein relate generally to a pressure sensor detecting a pressure difference of fluids, for example, gas or liquid.

### 2. Description of the Related Art

A differential pressure transmitter that detects and transmits a difference between a high fluid pressure generated on an upstream side of a measurement pipe having a diaphragm and a low fluid pressure generated on a downstream side is known (for example, JP H10-274587 A).

### BRIEF SUMMARY OF THE INVENTION

A pressure sensor that detects a fluid differential pressure includes a first port into which a high-pressure fluid is introduced and a second port into which a low-pressure fluid is introduced, and the first port is connected to, for example, an upstream side of a pipe which is a measurement target (hereinafter referred to as a measurement pipe), and the second port is connected to a downstream side of the measurement pipe. When the first port and the second port are connected to the measurement pipe, for example, if the first port or the second port is displaced from the measurement pipe, an excessive stress is applied to the first port or the second port when the first port or the second port is connected to the measurement pipe. In this case, an excessive stress is also transmitted to the diaphragm and a sensor unit in the pressure sensor, making it difficult to accurately detect the fluid differential pressure.

The embodiment of the present application provides a pressure sensor capable of preventing an excessive stress from being applied to a port and capable of accurately detecting a fluid differential pressure.

According to the embodiment, a pressure sensor comprises: a base including a first fluid receiving deformation of a first diaphragm, a second fluid receiving deformation of a second diaphragm, and a sensor unit detecting a pressure difference between the first fluid and the second fluid; a first port attached to the base and including a first flow path through which a third fluid serving as a measurement target is introduced into the first diaphragm; and a second port attached to the base and including a second flow path through which a fourth fluid serving as a measurement target lower in pressure than the third fluid is introduced into the second diaphragm. An outer diameter of the first port is equal to an outer diameter of the second port, and a diameter of the first flow path is smaller than a diameter of the second flow path.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a top view showing a pressure sensor according to the present embodiment.

FIG. 2 is a perspective view of FIG. 1.

FIG. 3 is an exploded perspective view of FIG. 1.

FIG. 4 is a cross-sectional view taken along IV-IV line in FIG. 1.

FIG. 5 is a cross-sectional view taken along V-V line in FIG. 1.

FIG. 6 is a partially cross-sectional side view showing a state in which the pressure sensor according to the present embodiment is attached to a measurement pipe.

### DETAILED DESCRIPTION OF THE INVENTION

An embodiment will be described hereinafter with reference to the accompanying drawings. In the drawings, the same portions or portions comprising the same functions are denoted by the same reference numerals.

### (Configuration of Embodiment)

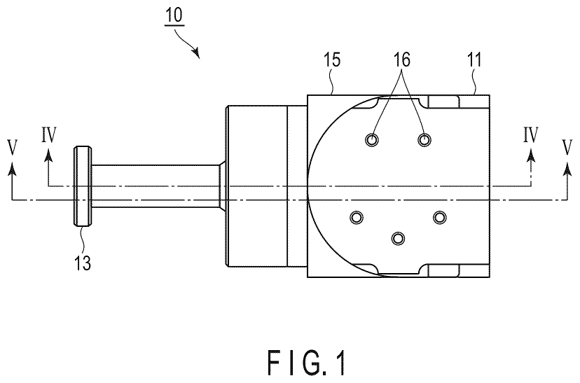

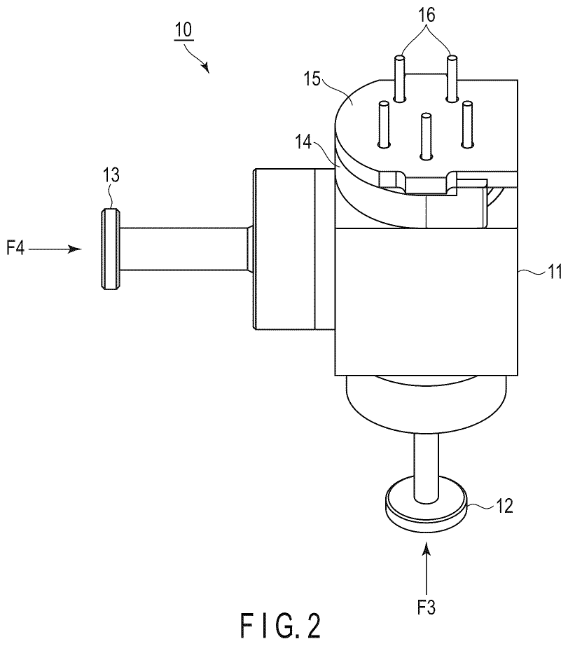

FIG. 1 to FIG. 6 show a pressure sensor 10 according to the present embodiment. The pressure sensor 10 is, for example, a pressure sensor capable of detecting a differential pressure between two fluids, but is not limited to this and may be a pressure sensor that detects the pressure of one fluid.

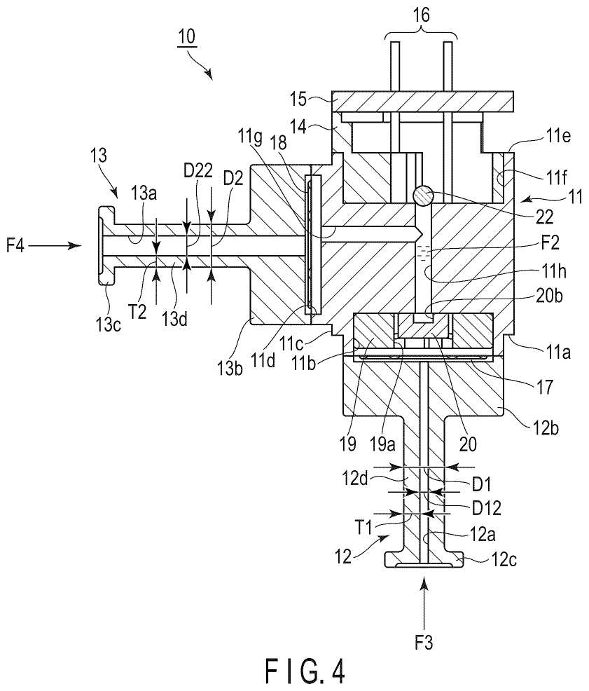

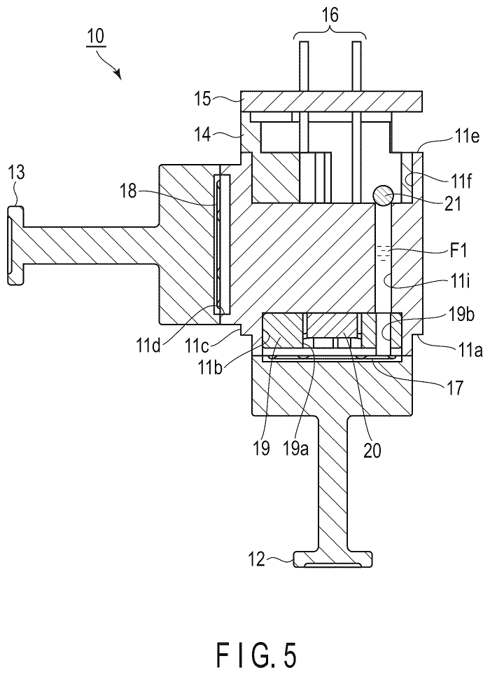

As shown in FIG. 1 to FIG. 3, the pressure sensor 10 includes a base 11, a first port 12 into which a fluid F3 to be measured is introduced, a second port 13 into which a fluid F4 to be measured is introduced, a spacer 14, a substrate 15, a plurality of lead pins 16, a first diaphragm 17, a second diaphragm 18, an adjustment member 19, a sensor unit 20, a first fluid F1 (shown in FIG. 5) and a second fluid F2 (shown in FIG. 4) which are fillers, and the like.

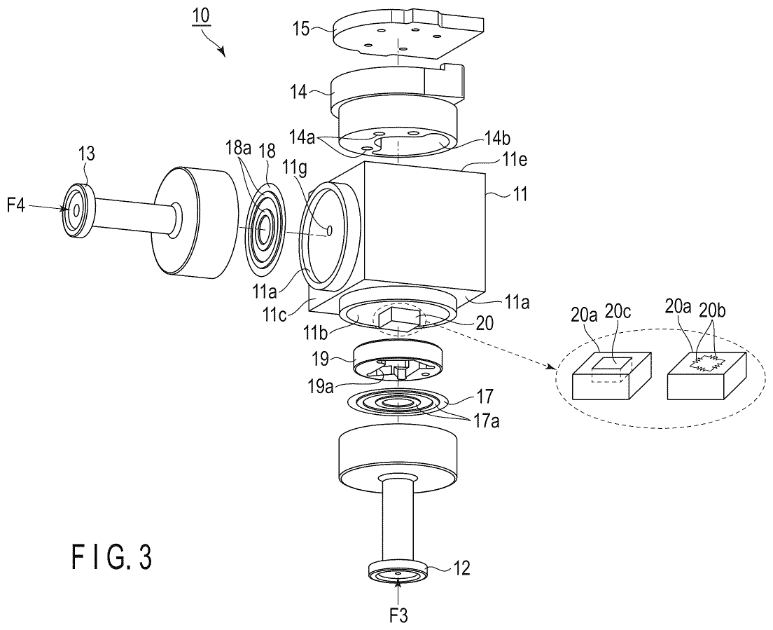

As shown in FIG. 3, the base 11 shaped in a rectangular parallelepiped is formed of metal, for example, stainless steel, or an alloy of, for example, iron, nickel, cobalt, and the like, and has six faces that intersect each other at right angles. A cylindrical first recess 11b is provided on a first surface 11a of the base 11. A bottom surface of the first recess 11b is located at a position deeper than the first surface 11a. A second recess 11d is provided on a second surface 11c orthogonal to the first surface 11a. A bottom surface of the second recess 11d is located at a position shallower than the second surface 11c. As shown in FIG. 4, a cylindrical third recess 11f is provided on a third surface 11e parallel to the first surface 11a. A bottom surface of the third recess 11f is located at a position deeper than the third surface 11e.

The spacer 14 formed of, for example, insulating resin is attached to the inside of the third recess 11f. An insulating substrate 15 is attached to the upper surface of the spacer 14. As shown in FIG. 3, the spacer 14 includes a plurality of holes 14a into which the plurality of lead pins 16 held through the substrate 15 are inserted respectively, and a large hole 14b into which the plurality of lead pins 16 are inserted all at once.

The plurality of lead pins 16 are formed of conductive metal. The plurality of lead pins 16 penetrate from the bottom surface of the third recess 11f of the base 11 to the bottom surface of the first recess 11b through the substrate 15 and the spacer 14. Each lead pin 16 located in the base 11 is placed in an insulating sheath (not shown), and is electrically insulated from the base 11 by each sheath.

As shown in FIG. 3 and FIG. 4, a pipe-shaped hole 11g is provided in the bottom surface of the second recess 11d. One end of the hole 11g is made to communicate with a middle part of a pipe-shaped hole 11h provided inside the base 11. One end of the hole 11h is located at the center of the bottom surface of the third recess 11f, and the other end is located at the center of the bottom surface of the first recess 11b. The holes 11g and 11h constitute a flow path.

The hole 11g is provided at a position offset from the center of the second recess 11d. More specifically, the hole 11g is arranged above the center of the second recess 11d.

The first diaphragm 17 is attached to the periphery of the first recess 11b, and the first recess 11b is closed by the first diaphragm 17. More specifically, the periphery of the first diaphragm 17 is welded to the periphery of the first recess 11b, and space is formed by the first diaphragm 17 and the first recess 11b.

The second diaphragm 18 is attached to the periphery of the second recess 11d, and the second recess 11d is closed by the second diaphragm 18. More specifically, the periphery of the second diaphragm 18 is welded to the periphery of the second recess 11d, and space is formed by the second diaphragm 18 and the second recess 11d.

The first port 12 is formed of the same material as, for example, the base 11 and is composed of a first flange 12b on the base side, a second flange 12c on the conduit side, and a pipe portion 12d connecting the both flanges, and a hole (also simply referred to as a first flow path) 12a serving as a first flow path is formed to penetrate the first flange 12b, the pipe portion 12d, and the second flange 12c.

The first flange 12b is attached to the periphery of the first recess 11b. More specifically, the periphery of the first flange 12b is welded to the periphery of the first recess 11b, and the first diaphragm 17 is covered. The third fluid F3 which is a measurement target introduced into the hole 12a from the second flange 12c is guided into space defined by the first diaphragm 17 and the end surface of the first flange 12b.

The second port 13 is formed of the same material as, for example, the base 11 and is composed of a third flange 13b on the base side, a fourth flange 13c on the conduit side, and a pipe portion 13d connecting the both flanges, and a hole (also simply referred to as a second flow path) 13a serving as a second flow path is formed to penetrate the third flange 13b, the pipe portion 13d, and the fourth flange 13c. The third flange 13b is attached to the periphery of the second recess 11d. More specifically, the periphery of the third flange 13b is welded to the periphery of the second recess 11d, and the second diaphragm 18 is covered. The fourth fluid F4 which is a measurement target introduced into the hole 13a from the fourth flange 13c is guided into space defined by the second diaphragm 18 and the end surface of the third flange 13b.

As described above, the second port 13 is arranged in a direction crossing the first port 12.

An outer diameter D1 of the first port 12 (more specifically, an outer diameter of the pipe portion 12d) is equal to an outer diameter D2 of the second port 13 (more specifically, an outer diameter of the pipe portion 13d) (D1=D2), and an inner diameter (diameter of the hole 13a) D22 of the second port 13 is larger than an inner diameter (diameter of the hole 12a) D12 of the first port 12 (D22>D12). For this reason, a thickness T2 of the second port 13 is thinner than a thickness T1 of the first port 12 (T2<T1).

Since the first port 12 and the second port 13 are manufactured of the same material, the rigidity of the second port 13 is smaller than that of the first port 12, and the second port 13 is easily deformed than the first port 12.

A sensor unit 20 is provided at a position opposed to the other end of the pipe-shaped hole 11h, inside the first recess 11b. As shown in FIG. 3, the sensor unit 20 is composed of a pedestal 20a and a plurality of strain gauges 20b provided on the surface of the pedestal 20a. The pedestal 20a includes a recess 20c in the central portion, and a thickness of the central portion is smaller than a thickness of the periphery. Therefore, the central portion of the pedestal 20a can be deformed. The pedestal 20a is fixed to the bottom surface of the first recess 11b using, for example, an adhesive such that the recess 20c is opposed to the other end of the pipe-shaped hole 11h.

The plurality of strain gauges 20b are arranged in a deformable central portion of the pedestal 20a on the surface opposite to the recess 20c of the pedestal 20a. The plurality of strain gauges 20b constitute a bridge circuit. The bridge circuit detects the deformation of the central portion of the pedestal 20a as an electrical signal. Since the configuration of the bridge circuit is not essential in the present embodiment, its detailed description will be omitted. The plurality of strain gauges 20b are electrically connected to the plurality of lead pins 16, and the output signal of the bridge circuit is taken out to the outside of the pressure sensor 10 via the lead pins 16.

An adjustment member 19 is provided around the sensor unit 20 and the plurality of lead pins 16 inside the first recess 11b. The adjustment member 19 is formed of an insulating material, such as ceramic. The adjustment member 19 has an outer diameter equivalent to the diameter of the first recess 11b, and is fixed to the bottom surface of the first recess 11b using, for example, an adhesive. The adjustment member 19 includes a housing part 19a as space for arrangement of the sensor unit 20 and the plurality of lead pins 16, and adjusts the amount of the first fluid F1 with which the space formed by the housing part 19a, the first diaphragm 17, and the first recess 11b is filled.

Furthermore, as shown in FIG. 5, the adjustment member 19 includes a hole 19b for introducing the first fluid F1 into the space. The hole 19b is arranged at a position facing one of the plurality of grooves 17a provided concentrically in the first diaphragm 17, outside the center of the adjustment member 19. More specifically, the hole 19b is arranged to face the outermost groove 17a among the plurality of grooves 17a.

The base 11 includes a pipe-shaped hole 11i serving as a flow path at a position facing the hole 19b of the adjustment member 19. One end of the hole 11i is arranged within the bottom surface of the third recess 11f, and the other end is arranged at a position facing the hole 19b of the adjustment member 19 within the bottom surface of the first recess 11b.

In the above-described configuration, for example, silicone oil is injected into the hole 11i from the third recess 11f side of the base 11 as the first fluid F1. The silicone oil injected into the hole 11i is injected into the first recess 11b from the hole 19b of the adjustment member 19, and space of the first recess 11b, the first diaphragm 17, the adjustment member 19, the sensor unit 20, and the plurality of lead pins 16 is filled with the silicone oil. Furthermore, after the hole 19b of the adjustment member 19 and the hole 11i are filled with silicone oil, one end of the hole 11i is sealed with, for example, a metal ball 21. More specifically, the ball 21 is welded to one end of the hole 11i.

In contrast, as shown in FIG. 4, for example, silicone oil is injected into the hole 11h from the third recess 11f side of the base 11, as the second fluid F2. The silicone oil injected into the hole 11h is injected into the recess 20c of the pedestal 20a serving as the sensor unit 20. Furthermore, the space formed by the hole 11g, the second recess 11d, and the second diaphragm 18 is filled with the silicone oil injected into the hole 11h. After the hole 11h is filled with silicone oil, one end of the hole 11h is sealed with, for example, a metal ball 22. More specifically, the ball 22 is welded to one end of the hole 11h.

In the above-described configuration, when the third fluid F3 is introduced into the first port 12 as a measurement target and the fourth fluid F4 is introduced into the second port 13 as a measurement target, the first diaphragm 17 is deformed by the pressure of the third fluid F3, and the second diaphragm 18 is deformed by the pressure of the fourth fluid F4. The force caused by the deformation of the first diaphragm 17 and the second diaphragm 18 is transmitted to the front and back surfaces of the sensor unit 20 by silicone oil, and a central part of the pedestal 20a is deformed. In accordance with the deformation of the central part of the pedestal 20a, the balance of the bridge circuit collapses, and the pressure difference between the third fluid F3 and the fourth fluid F4 from the bridge circuit is detected as an electrical signal.

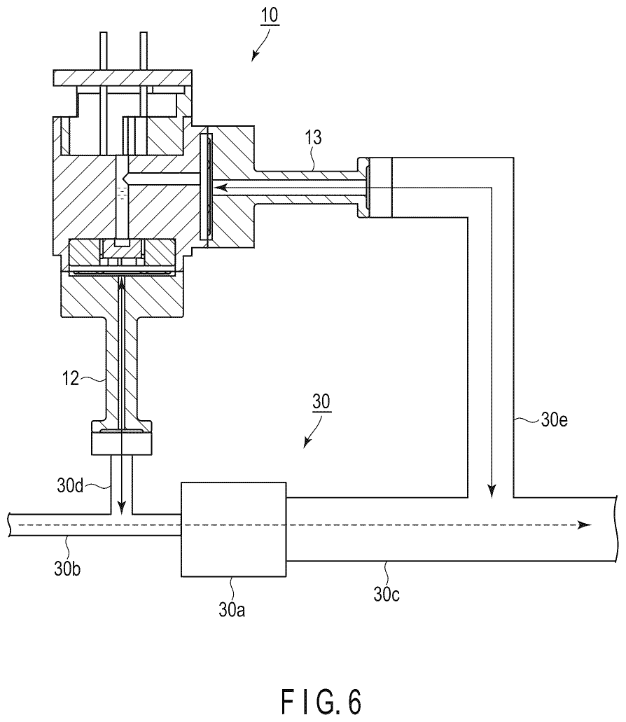

FIG. 6 shows a state in which the pressure sensor 10 according to the present embodiment is attached to the main flow path 30 serving as a measurement pipe. The main flow path 30 includes, for example, an orifice 30a as a throttle, a flow path 30b upstream of the orifice 30a, a flow path 30c downstream of the orifice 30a, a relay flow path 30d connected to the upstream flow path 30b, and a relay flow path 30e connected to the downstream flow path 30c. An end part of the relay flow path 30e, which is remote from the flow path 30c, is bent so as to be parallel to the flow path 30c.

When the pressure sensor 10 is attached to the main flow path 30, first, the first port 12 of the pressure sensor 10 is connected to the relay flow path 30d, and then the second port 13 is connected to the relay flow path 30e. In a case where displacement between the second port 13 and the relay flow path 30e occurs in a state in which the first port 12 is fixed to the relay flow path 30d, when the second port 13 is fixed to the relay flow path 30e, the second port 13 is deformed in accordance with the displacement of the second port 13. In other words, since the rigidity of the second port 13 is smaller than the rigidity of the first port 12, the displacement between the second port 13 and the relay flow path 30e is absorbed by the deformation of the second port 13. For this reason, stress on the second port 13, which is caused by the displacement can be reduced, and stress on the second diaphragm 18 and the sensor unit 20 in the base 11 can also be reduced. Therefore, the pressure difference between the fluid introduced from the first port 12 and the second port 13 can be accurately detected by the pressure sensor 10.

In the present embodiment, the difference from the pressure of the fluid introduced into the second port 13 is detected based on the pressure of the fluid introduced into the first port 12. For this reason, the stress is absorbed by the second port 13. However, when the difference from the pressure of the fluid introduced into the first port 12 is detected based on the pressure of the fluid introduced into the second port 13, the stress may be absorbed by the first port 12. In this case, the thickness T1 of the first port 12 may be made thinner than the thickness T2 of the second port 13.

In addition, in the present embodiment, it is required to improve the response performance on the upstream side of the main flow path 30 serving as a measurement pipe rather than that on the downstream side. For this reason, the inner diameter D12 of the first port 12 is made smaller than the inner diameter D22 of the second port 13 to increase the response speed. However, when the improvement in response performance on the downstream side is required, the inner diameter D22 of the second port 13 may be made smaller than the inner diameter D12 of the first port 12.

Incidentally, in the fluid introduced into the first flow path 12a, movement occurs due to the influence of the flow in the main flow path 30. In contrast, since the fluid introduced into the second flow path 13a is remote from the main flow path 30, the fluid is hardly influenced by the flow of the main flow path 30. For this reason, there is a possibility that deposits may accumulate in the flow paths. However, since the second flow path 13a has a larger inner diameter than the first flow path 12a, accumulation of deposits can be suppressed.

### (Advantageous Effects of Embodiment)

According to the above-described embodiment, since the rigidity of the second port 13 is smaller than the rigidity of the first port 12, the stress which occurs due to the displacement between the relay flow path 30e and the second port 13 can be absorbed by the deformation of the second port 13 when the pressure sensor 10 is connected to the main flow path 30 serving as a measurement pipe. Therefore, the stress on the second diaphragm 18 and the sensor unit 20 in the base 11 can be reduced, and the differential pressure of the fluid can be accurately detected.

In addition, the outer diameter D1 of the first port 12 and the outer diameter D2 of the second port 13 are equal and are formed of the same material, and only the inner diameter D12 of the first port 12 and the inner diameter D22 of the second port 13 are different. Therefore, since the first port 12 and the second port 13 can share parts and can also share parts of the processing steps, the manufacturing costs can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pressure sensor comprising:
a base including a first fluid receiving deformation of a first diaphragm, a second fluid receiving deformation of a second diaphragm, and a sensor unit detecting a pressure difference between the first fluid and the second fluid;
a first port attached to the base and including a first flow path through which a third fluid serving as a measurement target is introduced into the first diaphragm; and
a second port attached to the base and including a second flow path through which a fourth fluid serving as a measurement target lower in pressure than the third fluid is introduced into the second diaphragm, wherein
an outer diameter of the first port is equal to an outer diameter of the second port, and a diameter of the first flow path is smaller than a diameter of the second flow path.

2. The pressure sensor of claim 1, wherein
the second port is arranged in a direction crossing the first port.

3. The pressure sensor of claim 1, wherein
the base includes a first surface including a first recess, a second surface including a second recess and provided in a direction crossing the first surface, a first hole communicating a first bottom surface of the first recess with a second bottom surface of the second recess, and a third surface parallel to the first surface,
the sensor unit is arranged to cover the first hole, on the first bottom surface of the first recess,
the first diaphragm is attached to a periphery of the first recess,
an inside of the first recess closed by the first diaphragm is filled with the first fluid,
the first port is attached to the periphery of the first recess,
the second diaphragm is attached to a periphery of the second recess,
insides of the second recess closed by the second diaphragm, and the first hole are filled with the second fluid, and
the second port is attached to the periphery of the second recess.

4. The pressure sensor of claim 3, wherein
the base further comprises a second hole communicating the first bottom surface of the first recess with the third surface and is filled with the first fluid.

5. The pressure sensor of claim 3, wherein the first hole is further communicated with the third surface and is filled with the second fluid.

6. The pressure sensor of claim 3, further comprising:
an adjustment member arranged in the first recess and adjusting an amount of the first fluid.

7. The pressure sensor of claim 3, further comprising:
a plurality of lead pins penetrates the first bottom surface of the first recess from the third surface of the base and electrically connected to the sensor unit.
